(19) United States
(12) Patent Application Publication
(10) Pub. No.: US 2018/0044180 A1
(43) Pub. Date: Feb. 15, 2018

(54) METHOD FOR TREATING WATER WITH CHLORINE DIOXIDE

(71) Applicant: International Dioxcide, Inc., North Kingstown, RI (US)

(72) Inventors: Adrian Alan BURKE, North Kingstown, RI (US); Scott C. GLYNN, Coventry, RI (US); William J. HULSMAN, Warwick, RI (US); Michael TROTTIER, Saunderstown, RI (US); Neil ANDRE, Warwick, RI (US); Randy D. BELISLE, Moosup, CT (US); Peter GARRISON, Arlington, TN (US)

(73) Assignee: International Dioxcide, Inc., North Kingstown, RI (US)

(21) Appl. No.: 15/554,752

(22) PCT Filed: Feb. 8, 2016
(86) PCT No.: PCT/US2016/016943

§ 371 Date: Aug. 31, 2017

Related U.S. Application Data
(60) Provisional application No. 62/126,836, filed on Mar. 2, 2015.

(51) Int. Cl. C01B 11/02; B01J 19/00; F15D 1/02; E21B 43/12; E21B 41/00; C02F 1/76; B01J 19/24

(52) U.S. Cl. CPC C01B 11/024; C02F 1/76; B01J 19/002; B01J 19/006; B01J 19/24; E21B 43/124; E21B 41/0007; F15D 1/02; B01J 2219/00162; B01J 2219/00164; B01J 2219/00306

(57) ABSTRACT

A method for treating water with chlorine dioxide wherein the reactor is contained inside of the water supply line being treated and an eductor is used to draw in the chemical precursors. The method offers facilitated chlorine dioxide (ClO ₂) generation and safer operation over wider ClO₂ mass flow capacity, thus offering a more adaptable system for CLO₂ treatments. Noise reduction and ease-of-use versus traditional eductor-based ClO₂ generators are additional benefits from using this method.

### BACKGROUND OF THE INVENTION

Conventional chlorine dioxide (ClO₂) generators use either pumps or eduction to provide reactant flow and mix reactants to form ClO₂. Eduction is inherently safer because the reactant flows are immediately halted in the case of motive water loss and the likelihood of leakage related to pressurized chemical lines and pumping equipment is removed. The risk of overly pressurizing any potential ClO₂ gas pocket is also removed, as the eductor operates under vacuum during ClO₂ generation and ClO₂ is immediately diluted into the motive water supply. A limitation to eductor-based systems is lower turn down ratio, typically 4:1, compared to pump-based systems at 10:1.

Various combinations of chemical precursors can be used to generate ClO₂, and these are all familiar to those skilled in the art. The most common and affordable chemical precursor combinations are:
i. Sodium Chlorite, Sodium Hypochlorite, and Acid (where the acid is preferably hydrochloric acid);
ii. Sodium Chlorite and Acid (where the acid is preferably hydrochloric acid);
iii. Sodium Chlorate, Acid, and Reducing Agent (where the reducing agent is preferably hydrogen peroxide or methanol and the acid is either hydrochloric acid or sulfuric acid); and
iv. Sodium Chlorite and Chlorine (gas).

The eductor-based reactor assembly of the present invention can be applied to any of these or other chemical-based ClO₂ generator systems; however, specific modifications would be required for each chemical precursor combination in order to optimize ClO₂ yield and minimize the formation of unwanted by-products. ClO₂ is unstable as a liquid and explosive at vapor concentrations greater than 10% by volume. ClO₂ decomposes over time and cannot be shipped. However, aqueous solutions of ClO₂ generated at the application site can be safely handled and applied as long as decomposition conditions do not develop. Eductor-based systems provide inherently safe operation since the reactor is under vacuum while ClO₂ is being generated. The combined vacuum and flow dynamics of the eductor prevent explosive levels of ClO₂ vapor by rapidly diluting ClO₂ into the motive water supply. High concentration of ClO₂ is not allowed to develop and persist in the reaction zone at elevated pressure. The motive water driving the function of the eductor also promotes immediate dilution, which does not allow high concentrations of chlorine dioxide to persist or collect. In addition, in the instance that suitable motive water flow is not provided or process water flow is not detected, then automated valves on each of the reactant precursor feed lines will be closed to halt reactor operation.

Standard eductor operations require enough motive water flow to provide the suction force for the chemical feeds, but safe operational guidelines limit the final stream concentration to 3,000 ppm. This stream is then blended with the primary water header line further downstream, and ClO₂ is then diluted to achieve its proper application dosage in the full flow of the stream being treated. The limitation of 3,000 ppm at the eductor outlet in combination with the maximum motive water flow rate also imposes a limit on the maximum mass flow of ClO₂ that can be achieved. As the total daily production of ClO₂ increases, the pump used for the eductor motive water supply can be quite large and result in elevated energy requirements and capital costs for the system. The ability to use smaller motive water pumps specific to the ClO₂ generator would be preferred, and direct dilution into the entire process stream undergoing treatment is one means to circumvent limitations regarding mass flow capacity of ClO₂. The reactor assembly of the present invention offers a compact design and reduced footprint for a given pounds per day (PPD) ClO₂ production level.

There are various 2-part and 3-part systems that generate chlorine dioxide. Many of the ClO₂ generators use chemical dosing pumps instead of an eductor design. The pumps are suitable for low flow rates (generator capacities <100 lb ClO₂/day), although they are not as safe as eductors, especially for higher flow rates above 100 lb ClO₂/day. The hazards related to pumps originate from the pressurized operation of chemical reactant feeds that can be dead-headed to result in elevated pressure, which could initiate ClO₂ decomposition. Additionally, reactant leakage is more likely when the line is pressurized, as opposed to an eductor using vacuum to siphon the chemical feed at lower pressure. Because the vacuum creates a pressure below that of ambient, any pinhole or small defect in the process line will result largely in the suction of ambient air rather than excessive chemical leakage.

Once ClO₂ is generated in a standard reactor, the concentration is diluted to 3,000 ppm or less to be temporarily stored in a batch tank and/or piped to an application point at the target dosage. Extended length of pipe or bulk tanks that contain 1,000-3,000 ppm ClO₂ offer a considerable hazard should this fluid leak to the environment.

Noise originating from the eductor is another issue that can impede operator working conditions. Cabinetry and sound-proofing material are often used to dampen the decibel level of eductors and other turbulent process flow devices. In the case of chlorine dioxide generators, sound-proofing materials are generally not compatible with the chemicals in use, and cabinets can help to some extent, but they only have minimal impact in noise abatement. In addition, cabinets limit the access to the generators and result in more difficult maintenance and repairs. Reducing points of cavitation and turbulence (i.e. valves and 90 degree turns) can also reduce noise, but the inherent design of the system being operated will always have a minimum decibel level for a given production rate of ClO₂.

There have been many ClO₂ methods and apparatuses that have been patented, and pertinent examples are discussed below to distinguish this eductor-based reactor assembly from prior art.

U.S. Pat. No. 4,019,983 (Houdaille Industries, 1975) describes in a chemical distribution and mixing manifold that uses an ejector for ClO₂ dosing into a larger stream being treated. However, the ClO₂ in this case is not being generated in situ, and no reactor is incorporated into the design. Because the ClO₂ needs to be fed via a diluted stream, this has a lower flow capacity as opposed to a system that is generating ClO₂ on site via an in situ reactor. Additionally, it is not preferred to operate in this manner as upon system shut off, the feed lines containing ClO₂ will still be flooded with hazardous levels of ClO₂.

U.S. Pat. No. 8,663,481 (Infracor, 2014) describes a ClO₂ reactor that is contained by the process fluid to be treated, rendering an inherently safer design regarding reactor chemical leakage, which should remain contained in process flow instead of risking environmental and possible personnel exposure. Nevertheless, the use of pumps on the reactant feed lines could result in chemical leakage to the environment should line breakage occur. Using an eductor-based reactor assembly that is incorporated into the main process water line to be treated is a novel method for safely generating ClO₂. Using an eductor will produce a minimum pressure in the reaction chamber that is lower than that of the surrounding process stream being treated, and this is different from any pump-based reactor operation such as that explained in U.S. Pat. No. 8,663,481. In addition, the idea of a ClO₂ reactor being completely submerged by the water to be disinfected is not entirely novel as others have used this type of reactor system before (see http://www.isiasistemi.it/page/ourtechnology.asp?pag=3, U.S. Pat. No. 7,452,511; and U.S. Pat. No. 6,325,970); In all of these cited examples that discuss containment of the ClO₂ reactor in the process flow, the precursor chemicals are all pumped into the reactor rather than using eduction to siphon the chemical precursors into the reactor.

### SUMMARY OF THE INVENTION

An aspect of the invention includes a method for ClO₂ treatment that offers enhanced safety, facilitated operations, and greater adaptability as compared to state of the art systems. Enhanced safety is achieved by using eduction on the chemical precursor lines and immediately diluting generated ClO₂ into the primary water header being treated. Eduction prevents pressurization of any potential ClO₂ gas in the reaction zone and avoids the use of pumps for precursor chemical feeds. Immediate ClO₂ dilution into the water flow minimizes the risks of concentrated ClO₂ exposure.

Facilitated operation is achieved by having a reduced process footprint and a modular design that is easy to repair and maintain. The motive water flow can also be reduced because it is no longer required as the primary source of dilution. Instead, motive water flow can be reduced to the minimum required with respect to maximum precursor flow requirements—thus offering reduction in motive water pump sizing and cost as well. Noise reduction due to eductor sound dampening also allows for a more preferable working environment.

Greater adaptability is realized by the wider range of process flows and ClO₂ doses achievable for a given set of hardware (i.e. fixed eductor, chemical feed lines, etc. . . ) and motive water supply. Typical CO2 generators that operate off a slip-stream have a narrower window of operation because the output can be at maximum 3,000 ppm before it is diluted into the primary process stream. According to the present invention, however, the eductor output is rapidly diluted into the total process flow, thus allowing for higher than 3,000 ppm ClO₂ with the eductor-based reactor assembly. For a given PPD requirement of ClO₂ production, this results in a reduced motive water supply flow and a correspondingly smaller motive water supply pump and lower system footprint.

Another design aspect for enhancing safe operation is to prevent ClO₂ accumulation near the site of generation. This is achieved by continuously flushing the area around the eductor by using water injection around the eductor body as shown in FIGS. 1 and 2. This continuous flush design prevents a stagnant zone where ClO₂ accumulation might occur and create hazardous conditions, especially upon system shut down. To help prevent any elevated volumes near the generator where ClO₂ gas might collect, it is preferable to locate the reactor assembly at a low point on the process line with the eductor outlet pointing upward into the process stream.

Noise reduction is another positive attribute related to eductor containment. Eductors can produce significant noise related to liquid cavitation and hydrodynamic flow. The current eductor-based reactor assembly will be muffled by being largely contained within the process flow line, thus causing the sound to be transmitted through the annular water volume.

In order to stabilize the reactor assembly and add sensors as required, a support can be used to secure the reactor assembly inside the process flow line, thus the reactor is not entirely surrounded by the process flow being treated. The baffle also becomes a location for sensor incorporation (such as temperature and/or pressure sensors, pH, ORP, etc. . . ) to aid in monitoring reactor efficiency and performance. The baffle, as named, can also be designed to work in coordination with the water flush zone to promote suitable mixing of ClO₂ into the process stream and to prevent ClO₂ accumulation near the reactor assembly.

### DESCRIPTION OF THE DRAWINGS

FIG. 1 shows the schematic for the three-part eductor-based reactor assembly.

FIG. 2 shows a schematic for a two-part reactor assembly with reaction chamber upstream of the educator.

### DETAILED DESCRIPTION

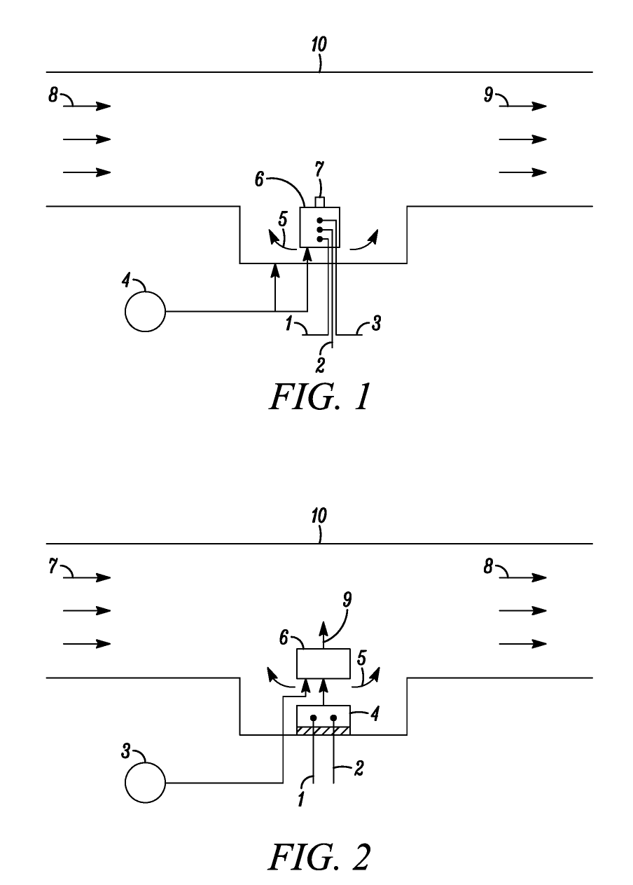

A novel eductor-based reactor assembly is presented in FIG. 1 that provides a wider range of ClO₂ mass flow capacity while maintaining safe operation. It also provides a compact design that facilitates maintenance, repairs, and overall operation of the ClO₂ generator.

As shown in FIG. 1, the motive water, 4, for the eductor, 6, is provided by a separate water supply or can be drawn from the primary water supply upstream of the reactor. The dosage can be varied by controlling the process flow influent, 8, as well as the chemical precursor feeds, 1, 2, and 3.

The reactor assembly is composed of an eductor, 6, housed within the main water pipe, 10. Motive water is sent through the eductor to produce vacuum on the reactant chemical feed lines. Liquid flow controllers and flow meters are used to control and monitor the reactant feed rates.

A water flush zone, 5, near the base of the reactor assembly prevents ClO₂ accumulation at the low point in the process line. Due to the high density of ClO₂, it is possible that it will descend from the application point 7 and accumulate at low regions if not appropriately mixed into the process stream effluent, 9. Flow for 5 can be provided by the motive water supply or another external water supply.

The eductor-based reactor can efficiently produce ClO₂ using any combination of generator chemistries. However, in the case of the acid-chlorite generator, a pre-mixing reaction chamber is required upstream from the eductor to achieve suitable conversion. FIG. 2 shows the 2-part acid/sodium chlorite reactor design. Acid and sodium chlorite feeds, 1 and 2, are directly mixed into a reaction chamber, 4, while being siphoned into the eductor, 6. Motive water, 3, is supplied to pull vacuum on the chemical feeds and is also used to flush the zone around the reactor assembly, 5. Process flow inlet, 7, is treated at the application point, 9, before leaving the process pipe, 10, as the treated process flow outlet, 8.

The invention is further illustrated with the following example.

### EXAMPLE

The range of flow capacity for a given eductor design was determined for standard ClO₂ generators versus novel reactor assembly designs. Using water flows to mimic 25 wt % NaClO₂, 33wt % HCl, and 12.5 wt % NaOCl precursor solutions, maximum and minimum ClO₂ production flows were determined according to fixed hardware, inlet pressure, and motive water flow rate.

Table I shows that the novel reactor assembly can achieve over an order of magnitude increase in ClO₂ production level for a given eductor design and set of basic operating conditions. In addition, while the turn-down ratio of standard systems is limited to 4:1, the novel reactor assembly can achieve at least 10:1 under most operating conditions.

TABLE I
Flow Capacity Range for Standard versus Novel Reactor Assembly
Design

| | Standard System (3,000 ppm max) | | | Novel Reactor Assembly | | |
|---|---|---|---|---|---|---|
| | Maximum | | | Maximum | | Motive |
| | capacity, | Turndown | Motive water | capacity, | Turndown | water flow, |
| | kg ClO₂/day | Ratio | flow, GPM | kg ClO₂/day | Ratio | GPM |
| Eductor size 1: | 175 | 4:1 | 11 | 2,800 | >10:1 | 11 |
| 1.25″ with | | | | | | |
| 0.191″ orifice | | | | | | |
| 0.290″ throat | | | | | | |
| Eductor size 2: | 425 | 4:1 | 27 | 3,200 | >10:1 | 27 |
| 1.25″ with | | | | | | |
| 0.300″ orifice | | | | | | |
| 0.358″ throat | | | | | | |

Besides the increased range in ClO₂ flow capacity, the novel reactor assembly was also much quieter on account of smaller motive water pump size and muffled eductor.

The reactor has a small dilution zone to application point. Because the eductor will be placed inside the main water pipe, it does not need to adhere to the 3,000 ppm maximum ClO₂ concentration at the eductor outlet. Safe operation is preserved as the concentrated ClO₂ stream is immediately diluted into the bulk process water flow. In cases where extended reaction time is required for reactor efficiency, the reactor assembly could include an extended eductor length that promotes higher conversion of reactants to ClO₂. An examination as to the acceptable volume and maximum allowable ClO₂ concentration in this zone would be required on a case-by-case basis. However, for most circumstances, it is expected that conversion will be sufficient and very rapid after the eductor, thus allowing for quick dilution into the main pipe header and safer operation by minimizing the total volume of high concentration ClO₂.

In the case of high temperature or other reactor malfunction, the reaction chamber can be flushed with water, which may or may not be tied in with the eductor water feed pump. In the case that active flushing is not possible, the reactor assembly flush can be supplied by a pressurized water tank that purges the free volume of the reaction chamber to a safe level of dilution. Some means of volume expansion can also be incorporated to prevent over pressurization of any ClO₂ that has off-gassed. This could include venting to a separate vessel that possibly contains an agent that effectively neutralizes ClO₂.

1. A method for ClO₂ treatment that uses an eductor-based reactor assembly to expand the ClO₂ flow capacity comprising:
an eductor to provide flows of precursor chemicals to generate the ClO₂
a mixing zone to ensure the ClO₂ is generated at safe operating pressures below explosive limits of the ClO₂;
a pipe to which the reactor assembly is mounted that allows for containment of the eductor inside the process stream and direct treatment of the process stream with the ClO₂;
a means to provide motive water supply for the eductor;
a control system that monitors precursor chemical flow rates and process flow rates to ensure that proper dilution and safe ClO₂ dosage is being applied to the process stream being treated.

2. The method according to claim 1 whereby the precursors are acid and sodium chlorite.

3. The method according to claim 1 whereby the precursors are acid, sodium hypochlorite, and sodium chlorite.

4. The method according to claim 1 whereby the precursors are chlorine and sodium chlorite.

5. The method according to claim 1 wherein a flushing zone is an additional component of the reactor assembly that prevents ClO₂ from accumulating within the process line and reactor assembly volume by continuously flushing volume outside of the eductor.

6. The method according to claim 1 wherein the reactor assembly is of modular design to accommodate interchangeable reactor assemblies for variable chlorine dioxide production capacity and turn down ratio.

7. The method according o claim 1 wherein the reactor assembly also comprises:
a first-stage reaction chamber located upstream of the eductor wherein neat precursor chemicals mix and react to form the ClO₂, and dilution water can optionally be added to dilute or flush said reaction chamber;
a second-stage reaction chamber located downstream of the eductor wherein neat precursor chemicals and the motive water mix and react to form the ClO₂ such that higher conversion of precursor chemicals to the ClO₂ is achieved prior to blending with the process stream being treated; and
optionally, additional reactor stages as required for enhancing safety and ClO₂ yield.

8. The method according to claim 1 wherein a baffle is included that supports the reactor assembly and allows for insertion of instrumentation such as thermocouples, probes, and sensors that can monitor the state of the reactor and also be used in the control system.

9. The method according to claim 1 wherein the reactor assembly offers noise reduction as opposed to an eductor-based reactor that is not housed within the process flow.

10. The method according to claim 1 wherein the range of the ClO₂ production and flow capacity can be changed by modifying the eductor, modifying the precursor feed lines, modifying the precursor concentrations, using multiple reactor assemblies, or any combination thereof.

11. The method according to claim 1 wherein the process reduces or eliminates additional water being added to the process.

12. A method for treating a liquid with chlorine dioxide, the method comprising passing a motive fluid through an eductor having an ejector end disposed in the liquid to be treated to draw precursor chemicals for the generation of chlorine dioxide into the eductor, contact the precursor chemicals within the eductor to generate chlorine dioxide, and eject the generated chlorine dioxide directly into the liquid to be treated.

13. The method according to claim 12, further comprising:
generating a flow of the liquid to be treated through a passage, wherein the passage comprises a reactor assembly comprising the eductor, and the eductor comprises:
one or more inlets for flow of precursor chemicals for the generation of chlorine dioxide into the eductor;
a reaction space for contact of the precursor chemicals to generate chlorine dioxide;
an entry for introduction of the motive fluid into the eductor for flow of the motive fluid through the eductor and out the ejector end thereof, wherein at least the ejector end is disposed within the passage for ejection of the generated chlorine dioxide directly into the liquid, whereby flow of the motive fluid draws the precursor chemicals into the reaction space via the inlets, and carries the generated chlorine dioxide directly into the passage; and
injecting the motive fluid through the eductor to draw the precursor chemicals into the reaction space, generate chlorine dioxide, and carry the chlorine dioxide into the liquid flow,

14. The method according to claim 13, wherein the eductor is disposed internally within the passage for being disposed within the flow of liquid, wherein generating the flow of liquid comprises containment of the eductor assembly within the liquid stream, with ejection of the generated chlorine dioxide directly into the liquid stream for direct treatment of the liquid stream with the generated chlorine dioxide.

15. The method according to claim 13, wherein the reactor assembly further comprises a control system configured for monitoring and adjusting flow rates of the precursor chemicals and flow rate of the fluid stream, and the process further comprises monitoring and adjusting the flow rates of the precursor chemicals and flow rate of the fluid stream to provide a predetermined chlorine dioxide dosage into the liquid.

16. The method according to claim 12, wherein the precursor chemicals comprise acid and sodium chlorite,

17. The method according to claim 12. wherein the precursor chemicals comprise acid, sodium hypochlorite, and sodium chlorite.

18. The method according to claim 12, wherein the precursor chemicals comprise chlorine and sodium chlorite.

19. The method according to claim 12, wherein the reactor assembly has no additional pumps for moving the precursor chemicals.

20. A direct treatment system for generating chlorine dioxide and treating a liquid with the chlorine dioxide, the system comprising:
a passage for flow of the liquid therethrough; and
an eductor comprising:
one or more inlets for flow of precursor chemicals for the generation of chlorine dioxide into the eductor;
a reaction space for contact of the precursor chemicals to generate chlorine dioxide;
an ejector end within the passage for ejection of the generated chlorine dioxide directly into liquid within the passage; and
an inlet for introduction of motive fluid into the eductor for flow of the motive fluid through the eductor and out the ejector end thereof, wherein flow of the motive fluid draws the precursor chemicals into the reaction space to generate the chlorine dioxide, and ejects the generated chlorine dioxide into the passage.
